(19) United States
(12) Patent Application Publication
(10) Pub. No.: US 2005/0127154 A1
(43) Pub. Date: Jun. 16, 2005

(54) Device for receiving fluid current, which fluid current is used to control an electronic or computer system

(76) Inventor: Pierre Bonnat, Grieges (FR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/981,039

(22) Filed: Nov. 3, 2004

Related U.S. Application Data
(60) Provisional application No. 60/517,038, filed on Nov. 3, 2003.

(51) Int. Cl. G06D 1/00; G06M 1/12

(52) U.S. Cl. 235/200 R

(57) ABSTRACT

A device to facilitate a user interface of a computer system utilizing fluid flow through the device, for example human breath. The device includes a body that defines a fluid current channel with an inlet and an outlet. A member is attached to the body and is capable of motion in response to fluid flow through the fluid current channel. The device may include a measuring device to process the movement of the member and generate an electrical signal.

### RELATED APPLICATION

The present application is related to, incorporates by reference and hereby claims the priority benefit of the following patent application, assigned to the assignee of the present application:
(1) U.S. Provisional Patent Application No. 60/517,038, filed Nov. 3, 2003, entitled “Device for receiving fluid current which fluid current is used to control an electronic or computer system”

### FIELD OF THE INVENTION

The present invention relates in general to controlling a computer system or an electronic system, and, in one exemplary embodiment, to a device to control an electronic or computer system by means of a fluid flow and a method of manufacturing the same.

### BACKGROUND OF THE INVENTION

Input devices for entering commands into a computer or electronic system are currently available in a variety of forms and configurations. Many such input devices take the form of a keyboard, touchpads, mouse or trackball device. There is an increasing trend of reducing the size of the input devices as work space is reduced or not available. Consequently, it is harder to use such devices without causing stress on the user's fingers, wrist and forearm. Pointing device designers and manufacturers are continually attempting to design devices that are comfortable for the user to operate for long periods of time and reduce Repetitive Stress Injuries.

The U.S., Intelligent Transportation Systems and In-Vehicle Internet converge with phones, infotainment and GPS to turn vehicles, such as automobile and aerospace vehicles, into moving-communicating-spaces.

In relationship to this evolution, safe and easy navigation tools are useful to allow a natural usage of these resources. Also, for reasons of cost constraints and limited instrument panel space, motor vehicle manufacturers are looking towards more integrated driver information systems. So far, touch screens, trackballs and rocker switches have proved to be unsuitable for safety reasons. This is especially so when such input devices require the user to use his hands to operate the devices. Frequently, complex GUI applications are used for such input devices, which again is unsuitable for such environments.

With the convergence of technologies, many computer and electronic applications are increasingly more complex. Frequently, a user is required to perform multiple tasks at any one time. Therefore, hands-free pointing and navigation tools provide means to provide multiple inputs. For example, in electronic music performances, a player may need to provide input to both the musical instruments and computer systems. And in most situations, several input devices, such as a keyboard and a mouse, are used. In another example, a maintenance engineer may probe circuit boards while navigating schematics. Hands-free devices provide a convenient way for the user to provide input to the system.

In some exemplary situations, such as multimedia and gaming applications, hands-free devices may enhance a user's experience. For example, with the advent of so-called TVPCs, which are a fusion of PCs centric and TVs centric technologies, TV sets are operated through GUIs comparable to PCs. A hands-free device enables the user to input his control and command conveniently.

### SUMMARY OF THE INVENTION

According to the present invention there is provided a device for receiving a fluid current, which fluid current is used to control an electronic or computer system, the device including a body having at least one channel therein; a measurement device to measure a fluid current, the measurement device being located at or near an end of each of the at least one channel to measure the fluid current at or near said end.

### BRIEF DESCRIPTION OF THE DRAWINGS

FIG. 1 is a schematic view of a holder for holding an input device configured in accordance with an embodiment of the present invention proximate to a user's head.

FIG. 2 illustrates an input device configured in accordance with an embodiment of the present invention and having four channels therein;

FIGS. 3a-3b illustrates an input device configured in accordance with an embodiment of the present invention and having three channels therein;

FIGS. 4a-4b illustrates an input device configured in accordance with an embodiment of the present invention two channels therein and with or without an exhaust;

FIGS. 5a-5c illustrates various exemplary embodiments of channeling for an input device configured in accordance with an embodiment of the present invention;

FIG. 6a-6b illustrates various exemplary embodiments of different channels for an input device configured in accordance with an embodiment of the present invention;

FIG. 7 illustrates various modes of a vibrating member, according to one exemplary embodiment of the present invention;

FIG. 8 is a schematic illustration of the design of a two-part member for an input device configured in accordance with an embodiment of the present invention;

FIG. 9 is a schematic illustration of the use of two members, one behind the other, for an input device configured in accordance with an embodiment of the present invention;

FIGS. 10a-10b illustrate different member configurations and a different device configurations for an input device configured in accordance with the present invention;

FIGS. 11a-11c show various exemplary embodiments of an exhaust for an input device configured in accordance with an embodiment of the present invention; and

FIG. 12a-12d illustrates various simulation results of a vibrating member for an input device configured in accordance with the present invention.

### DETAILED DESCRIPTION

Embodiments of the present invention are particularly useful as pointing devices, and more generally in connection with command and control technology aimed at human computer and computerized appliances interaction, based on airflow.

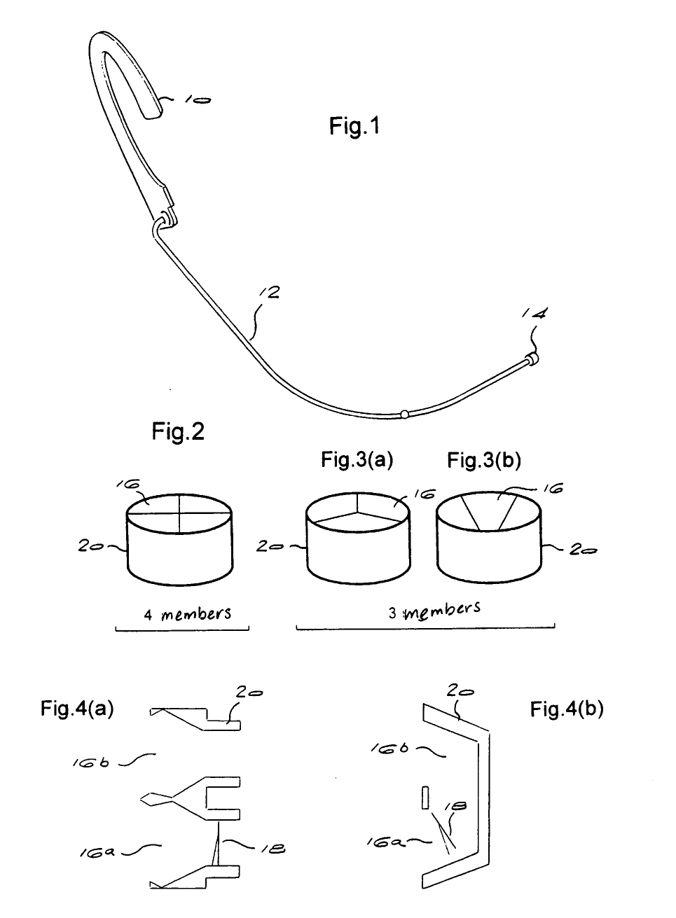

Referring to FIG. 1, an exemplary holder for an input device configured in accordance with an embodiment of the present invention is shown. The holder includes an earpiece 10 and an arm 12 extending from the earpiece 10. At the end of the arm 12 is a device 14, configured according to one embodiment the present invention, for receiving fluid current, which fluid current is used to control an electronic or computer system as will be described in more detail below.

The device 14 has one or more means for measuring fluid current including members to be deflected or moved from a fixed position by fluid current, for example human breath pressure. The deflection or movement is sensed and converted to an electrical signal to be used for pointer or other control and command operations.

Various methods of sensing the deflection or movement of the members have been described and implemented and are either electromagnetic, optical, or ultrasonic. Independent of the method of sensing, the member motion is controlled by a number of physical features of the device itself and by the way the pressure or fluid current is input. The member undergoes bending, vibration or other movement depending on these factors.

In one embodiment, the member is generally elongated and connected at an end thereof to a body of the device 14. Fluid current hitting the member causes the member to bend or vibrate.

In any event, fluid current flows from a user's mouth. The fluid current may be breathed air, typically blown out from the user's mouth. The fluid current passes through the open space between the user's mouth and the device 14 as there may be no direct contact between the user and the device 14.

The fluid current then flows into the device 14 and is channeled onto the member and then out of an exhaust. These features will be described in more detail below.

There are various parameters involved at the different levels, which effect the fluid current. Firstly, the size of the mouth opening will affect how focused or unfocused the fluid current is. For example, the fluid current velocity will be determined by the breathed air expelled from the mouth.

The present invention uses low ranges of pressure, as low as the phonation pressures (i.e., pressure levels required to speak). Sub-glottal pressure (pressure generated by the lungs) is usually 391-979 Pa, relative to atmospheric pressure (=101260 Pa at sea level and 0° C.). In absolute terms, this means that by blowing a little harder than the pressure it generally takes to speak, a user can use the device 14 (i.e., manipulate the member thereof by breadth control so as to produce desired effects, for example, controlling a computer system). The average shape of the opening the mouth is almost an ellipse of 4 mm by 8 mm, including variations possibly related to morphology. The flow velocity created at the mouth has a wide range depending on how hard a person can breathe. The upper limit of this range would also change from person to person. The range which will be used in connection with many embodiments of the present invention is in the lowermost part of this range for ease of use. In relationship to the system, the flow is controllable from 1.2 to 2 ms-1, and starts to be stressful above 2.5-3 ms-1.

In determining the position of the device 14 with respect to the mouth of the user, a position was sought with no direct contact. Analysis of pressure and flow velocity produced by the mouth at various distances from the mouth determines the distance at which the device can be placed from the user. The velocities shown below can be easily achieved at these distances.

| Distance (mm) | Average Breath Velocity ms⁻¹ |
|---|---|
| 150 | .4 |
| 100 | .7 |
| 70 | 1.1 |
| 60 | 1.3 |
| 50 | 1.6 |
| 40 | 2.1 |
| 30 | 2.5 |

Similarly, the area of focus at these distances helps determine the appropriate distance between members. It has been confirmed with experimentation that the area of focus decreases very little with distance between 20 mm and 45 mm from the mouth. In these distances, the area of focus is a 7 to 9 mm diameter circle.

Within the device itself, members can be positioned flush to the top of the device or just below the top of the device or for example in the case of the vibration embodiment, deeper in the device. When the member is not flush to the top of the device, a channeling effect is provided between the member and the top of the device.

The exemplary device 14 seeks to provide the functionalities of a pointing device, such as a computer mouse. In this case, a two axis pointing is sought. A four-member implementation is logical (X−, Y+, X+, Y−), however, it inherently reduces the surface of each member, given the size requirement for the device. An example of a four member device is illustrated in FIG. 2.

Alternatively, a three member design could be used wherein three channels 16 each include a member (not shown) located therein or at an end thereof. Two exemplary embodiments of a three-channel device are shown in FIGS. 3a and 3b.

The increase in length illustrated in FIG. 3b may assist in sensing depending on the type of sensing as the member located in the channels illustrated in FIG. 3b will be less angled at the end of their displacement. There is no inherent limitation of the number of members and sensing elements, and a two members design may be implemented as well, in relation with the processing software.

Because the channels 16 in the embodiments of device 14 shown in FIGS. 2, 3a and 3b are close together, the members located therein are also close together meaning that all the members are likely to be deflected at the same time by distinct amounts and the processing software used to correlate the deflections with commands will need to take the variations between these amounts into account.

FIGS. 4a and 4b illustrate two exemplary embodiments of a two-channel device, which includes a single member 18 located in or at an end of one of the channels.

In this embodiment, the device includes a body 20 having a first channel 16a and a second channel 16b therein. In FIG. 4a, the channels 16a and 16b are illustrated with an exhaust while in FIG. 4b the channels are illustrated with no exhaust.

In FIG. 4b, the channels are in fluid current connection with one another so that fluid current is able to flow in a first direction when fluid flow is introduced through the first channel 16a and fluid current flows in a second direction in the first channel 16a when fluid current flow is introduced in the second channel 16b. This essentially means that when a user blows through inlet 16b with no member therein, the member 18 is deflected in a first direction and when the user blows in channel 16a, the member 18 is deflected in a second direction (in this case, which is opposite to the first direction).

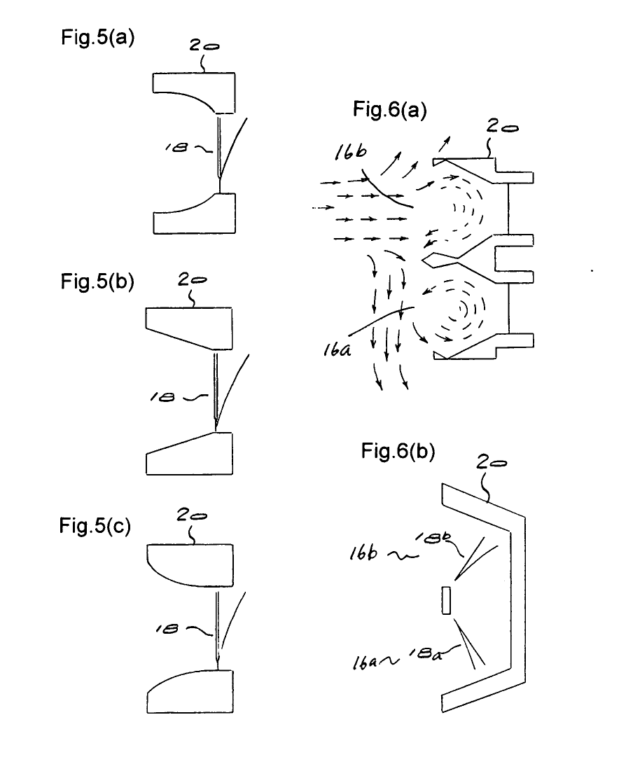

The breath of the user hitting a plane surface has a specific velocity profile and a specific pressure profile and channeling the breath is one way to achieve an increase in pressure on members to get significant deflections of a member and thereby achieve improved sensing. In order to channel the fluid current, an internal surface of one or more of the channels may be shaped to effect the flow of fluid current through the channel. Various exemplary embodiments of channels are illustrated in FIGS. 5a to 5c.

If the size of the members is considerably reduced and they are fixed away from each other, then the use of channeling to focus the flow can become important. For example, in a very small device such as MEMS (Micro-Electro-Mechanical Systems), channeling may be used to avoid any direct exposure of the members to the ambient environment. The difference in displacements for the members in the cases illustrated in FIG. 5a to 5c is approximately 5 to 20%.

Particularly, the channel's internal surface may be shaped to affect the flow of fluid current in such a way that fluid current flowing through one channel diminishes fluid current flowing through another of the channels. This is illustrated in FIGS. 6a and 6b. In this way, blowing on one member prevents the opposite member from deflecting, potentially helping the sensing part of the system in obtaining clearer signals. More complex designs may help improve the signal and avoid direct exposure of the member at the same time.

As illustrated in FIG. 6a, the body 20 of the device 14 includes a first channel 16b and a second channel 16a, the first channel 16b and the second channel 16a being in fluid current connection with one another. The first channel 16b is configured to permit the fluid current to flow in a first direction therein and to exit in a second direction, and the second channel 16a is configured to admit the fluid current flow in the second direction. The inner wall of the first channel 16b is shaped to direct the fluid current to flow from the first direction to the second direction, wherein the fluid current flow in the second direction is diminished from the fluid current flow for the first direction.

As illustrated in FIG. 6b, the body 20 of the device 14 includes a first member 18b attached to the first channel 16b and a second member 18a attached to the second channel 16a, wherein the first member 18b and the second member 18a are connected to a fluid current measuring device. The body 20 further includes an opening in the first channel 16b and wherein the second channel 16a is configured to permit the fluid current to flow from the first channel 16b to the second channel 16a. The device 14 is configured to direct the fluid current to flow in a first direction through the first channel and in a second direction through the second channel. In addition, the first member 18b and the second member 18a are arranged so that the fluid current impinges upon the first member 18b before the second member 18a.

Referring now to the members themselves, the members' size should be minimized while the area of the member exposed to the pressure needs to be maximized to get the maximum effect of the pressure. Aligning the members at an angle may be disadvantageous even with channeling, as the angled members eventually aid in channeling. The vertices of the member shape may be rounded for ease of manufacture. Thickness, elasticity and density of the material of the member are calculated based on the maximum travel that is required at the sensing stage for the functioning of the device. Beyond 0.1 mm thickness, due to available pressure from the user, the deflection required is hard to achieve. The effect of self-weight notably as to holding the rest position is seen with increase in length or with lower elasticity plastics. The elasticity is calculated in terms of the Young's modulus of elasticity. The elastic force has to be near to the sum of self-weight and possibly weight of added material (e.g., ferromagnetic particles which will be described in more detail below). The deflection may be described as follow:
Initial Deflection=self weight+added weight−elastic force
Final Deflection=stress breath (pressure)+[self weight+added weight−elastic force]

The initial displacement is preferably minimized and the final displacement maximized. To achieve this, breath pressure could be increased, but as is indicated above, the breath pressure is almost a constant. It can be increased only by getting closer to the device.

The added weight is preferably decreased even though this might have limitations on the sensing side.

Another alternative is to increase the area in which the breath pressure acts, yet avoiding being disadvantageous for the user as he/she would have to move his/her chin, head or neck to change directions, etc.

The factor of self-weight is usually quite negligible, for instance for polymers or rubbers with high elasticity.

As has been described above, the members can either be bending members or vibrating members.

Design of Bending Members

The maximum deflection is about 35-45% of the length in the case of plastic members. The range can go higher in case of rubber-based members or with rubber added.

Exemplary Calculations for Plastic Members.
Length=L
Maximum deflection expected is approximately 0.4 L
Area under pressure=A_{P}
Breath Pressure=P
Pivot width (can be changed to tune performance)=W_{P}
Added mass=M_{A}
Density=D
Maximum deflection=Del
Young's modulus to be determined=Y
Thickness of member to be determined=H
Self weight=D*H*A_{P}*g (g=9.8 ms⁻²)
Added weight=M_{A}*g
Wt1=self weight+added weight
Initial Deflection

$$Del1 ∼ \frac{( Wt1 ) * {L}^{4} * 12}{8 * Y * {W}_{P} * {H}^{3}}$$

Pressure at the member P˜3 Pa

$$\begin{matrix}Let Wt2 = self weight + added weight + pressure at member \\ = Wt1 + P\end{matrix}$$

Final Deflection

$$Del2 ∼ \frac{( Wt2 ) * {L}^{4} * 12}{8 * Y * {W}_{P} * {H}^{3}}$$

The difference Del2−Del1 should be maximized to provide optimum range for the processing side of the application.

$$\begin{matrix}Del2 - Del1 ∼ \frac{( Wt2 - Wt1 ) * {L}^{4} * 12}{8 * Y * {W}_{P} * {H}^{3}} \\ ( {L}^{4} * 12 ) / ( 8 * Y * {W}_{P} * {H}^{3} ) = MF or material factor . \\ Del1 ∼ Wt1 * MF \\ Del2 ∼ Wt2 * MF \\ Del2 - Del1 ∼ ( Wt2 - Wt1 ) * MF\end{matrix}$$

By changing MF—by increasing it—, Del2−Del1 can be increased. But this would imply an increase in Del1 too. And because Wt2−Wt1 is small, the increase in MF has to be quite large. The other solution is to increase Wt2−Wt1, by reducing the added mass.

The pivot width has certain restrictions based on the shear strength of the material.

$$\begin{matrix}Shear modulus of elasticity = σ \\ Shear stress = Maximum Force acting / Area at pivot \\ = Wt2 * {A}_{P} / ( {W}_{P} * H )\end{matrix}$$

As W_{P} decreases, shear stress increases and can break the member at the pivot point. The shear strain or the shift in area at the pivot will therefore be kept to a minimum.
Shear strain=(shear stress)/(σ)

Typical σ values are much higher than Wt2. Hence W_{P}*H should compensate for this. H is about 0.0001 m or 0.1 mm. This is a typical member thickness.

Hence for an A_{P} of about 25 mm², WP is approximately 2-3 mm. For A_{P} approximately 10 mm² W_{P} can be as low as 1 mm.

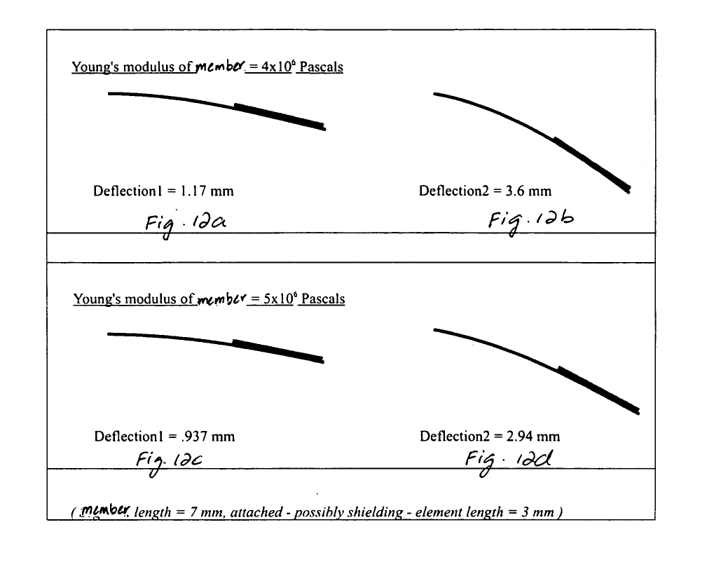

As has been referred to above, it is possible to add a ferromagnetic strip or layer, for example, on top of a member for shielding. In an exemplary embodiment, a member has a length of 7 mm and includes a ferromagnetic strip of 3 mm. Examples of the simulation of the member are illustrated in FIGS. 12a to 12d. As illustrated in FIGS. 12a and c, the members are at rest position with no stress. The members in FIGS. 12b and d are deflected when stressed with identical pressure and velocity.

Design of Vibrating Members

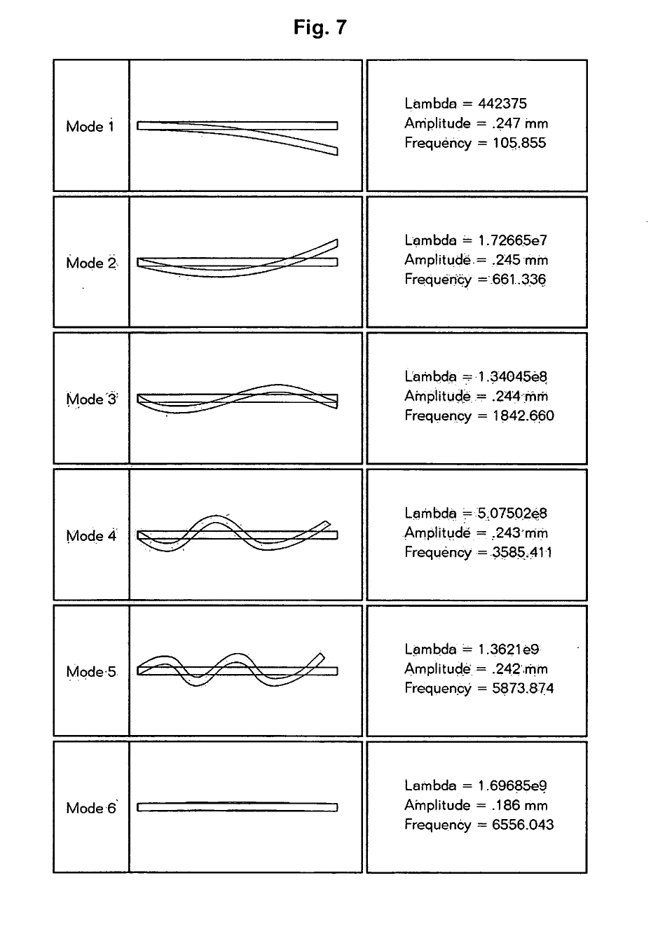

The vibration of a member is a combination of the 6 modes illustrated in FIG. 7. FIG. 7 illustrates an exemplary simulation for a 2 mm member.

These modes and the frequencies are the natural frequencies of vibrations of these members, while the actual frequencies that will be measured are the forced frequencies caused by the changing pressures.

In a further aspect of the present invention, a member for use in the above described devices includes a first part having a relatively smaller surface area and a relatively higher elasticity, while a second part has a relatively larger surface area and a relatively lower elasticity.

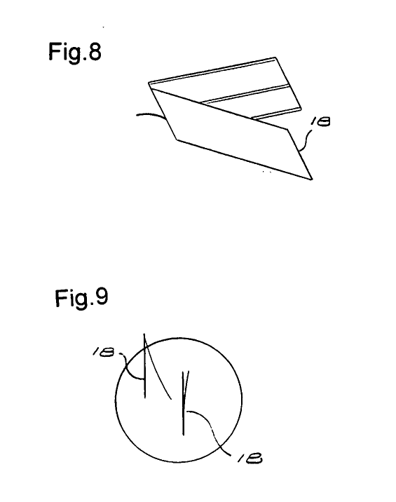

The part with higher elasticity holds the other part and is fixed. The other part increases the area at which the pressure is applied and transfers this to the first part. Increasing the area at the top increases the effect of pressure. This is illustrated schematically in FIG. 8.

Referring to FIG. 9, by using two members in place of one, and dividing the same range of input pressure for one member such that one member deflects only after the other has deflected to some extent, the sensing may be made easier, and such an embodiment also allows special designs such as implementation of 3D GUI, where a layer of members, possibly positioned underneath—though not necessarily superimposed on—the members to be impacted first by the breath flow, deflects after the other has deflected to some extent, thus coming to add 3D motion when pressure allows increasing deflection. Using two smaller members would therefore help replace a larger member and shrink the device, or facilitate 3D pointing implementation, as well as facilitating a number of options to specific Human Computer Interaction advanced functionalities (e.g., zoom).

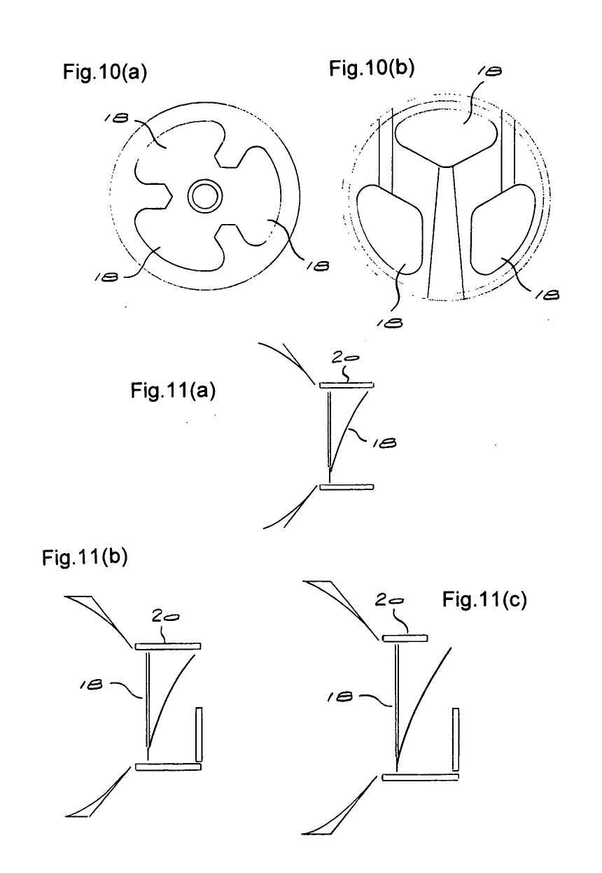

It is also possible to adapt the design for larger members. For example, for the device with three members shown in FIG. 10, as an exemplary embodiment of a three sensing systems solution, the member size is increased in the figure without increasing the device size.

Also, by increasing the length in this way, the angle at which the member aligns at the end of travel is much smaller. This may help the sensing (depending on type of sensing, e.g., this might get the sensors and members more parallel at the end of displacement). The simulation for such a case is discussed below. The final portion that the fluid current flows through is out of an exhaust.

While in the case of bending members an immediate exhaust may waste a lot of user's energy and would not result in a steady output, in the case of vibrating members the pressure on the members is such that as soon as the member closes part of the exhaust, the pressure would again decrease. Hence there would be an increase and decrease of pressures that would cause vibrations.

Quite similarly, a very late exhaust creates more back pressure and so decreases the possible deflection when bending members are implemented, whereas a very late exhaust helps increase the input pressure thus increasing vibration frequency. Positioning of exhaust is designed according to the types of member and channels to be implemented.

FIG. 11a shows a channel with a through exhaust. FIG. 11b illustrates a channel with a partial-through exhaust and FIG. 11c illustrates a channel with a partial through exhaust and a partial side exhaust.

It is also possible to implement the present device with no channeling and a complete exhaust.

The exhaust increases ease of use and efficiency of the device 14. A through exhaust, although beneficial, may be difficult to implement in certain embodiments due to constraints of printed circuit boards and other components. Through exhausts, and tiny holes, also help prevent external winds from generating unwanted stresses on the members, even in heavy winds—given, in addition, that the processing part of the system (e.g., embedded software) is to be designed so as to discard possible outputs from sensors that would result from such external disturbances (e.g., a very heavy wind would stress all of the members in a mostly identical and significant way, thus not being output as a desired interaction, while winds emitted when the user is speaking would possibly result in no more than a slight motion of the pointer, as is very usual with mice or touchpads, and not in a click or similar critical interaction). The distance from the free end of the member to the exhaust is considered negligible to the side of the device, and paths between them should remain unblocked.

The present invention allows a great number of interaction modes, in a variety of environments, with very diverse specifications. Applications include mobile pointing devices in laptop, computer system, wearable systems for military computing, and specific systems to be used in very harsh environments, and further includes Java-based contexts such as Telematics, among other potentialities.

Thus, a device for receiving fluid current, which fluid current is used to control an electronic or computer system has been described. Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

1. A device for receiving a fluid current to provide input to a computer system, the device including:
a body having at least one channel with an inner wall, an inlet and an outlet; and
at least one member anchored to the at least one channel, wherein the at least one member is movable in response to the fluid current.

2. The device of claim 1, wherein the at least one member is attached to the inner wall of the at least one channel.

3. The device of claim 1, wherein the at least one member is attached to at least the inlet or the outlet of the at least one channel.

4. The device of claim 1, wherein the at least one member is connected to a fluid current measuring device.

5. The device of claim 4, wherein the fluid current measuring device is at least one of an electromagnetic transducer, a light source, a light sensor and a piezo electric transducer.

6. The device of claim 1, wherein the at least one channel includes a first channel and a second channel, the first channel and the second channel being in fluid current connection with one another.

7. The device of claim 6, wherein the first channel is configured to permit the fluid current to flow in a first direction therein and to exit in a second direction, and the second channel is configured to admit the fluid current flow in the second direction.

8. The device of claim 7, wherein an inner wall of the first channel is shaped to direct the fluid current to flow from the first direction to the second direction.

9. The device of claim 8, wherein the fluid current flow in the second direction is diminished from the fluid current flow for the first direction.

10. The device of claim 9, wherein an outlet of the first channel is partially blocked.

11. The device of claim 6, further including a first member attached to the first channel and a second member attached to the second channel, wherein the first member and the second member are connected to a fluid current measuring device.

12. The device of claim 11, further including an opening in the first channel and wherein the second channel is configured to permit the fluid current to flow from the first channel to the second channel.

13. The device of claim 12, wherein the device is configured to direct the fluid current to flow in a first direction through the first channel and in a second direction through the second channel.

14. The device of claim 13, wherein the first and the second members are arranged so that the fluid current impinges upon the first member before the second member.

15. The device of claim 14, wherein the first member and the second member each move in response to the fluid current.

16. The device of claim 11, wherein an outlet of the first channel and an outlet of the second channel are each blocked.

17. The device of claim 1, wherein the at least one member includes a first part having a relatively smaller surface area and a relatively higher elasticity and a second part having a relatively larger surface area and a relatively lower elasticity.

18. An apparatus for receiving a fluid current to provide input to a computer system, the apparatus including:
means for defining a body of at least one channel with an inner wall, an inlet and an outlet; and
means for anchoring at least one member to the at least one channel, wherein the at least one member is movable in response to the fluid current.

19. The apparatus of claim 18, wherein means for anchoring at least one member to the at least one channel includes attaching the at least one member to the inner wall of the at least one channel.

20. The apparatus of claim 18, wherein means for anchoring at least one member to the at least one channel includes attaching the at least one member to at least the inlet or the outlet of the at least one channel.

21. The apparatus of claim 18, further including means for attaching at least one member to a fluid current measuring device.

22. The apparatus of claim 21, wherein the fluid current measuring device is at least one of an electromagnetic transducer, a light source, a light sensor and a piezo electric transducer.

23. The apparatus of claim 18, wherein the at least one channel includes a first channel and a second channel, the first channel and the second channel being in fluid current connection with one another.

24. The apparatus of claim 23, including means for the first channel to provide the fluid current to flow in a first direction therein and to exit in a second direction, and means for the second channel to admit the fluid current flow in the second direction.

25. The apparatus of claim 24, including means to shape an inner wall of the first channel to direct the fluid current to flow from the first direction to the second direction.

26. The apparatus of claim 25, wherein the fluid current flow in the second direction is diminished from the fluid current flow for the first direction.

27. The apparatus of claim 26, wherein an outlet of the first channel is partially blocked.

28. The apparatus of claim 23, further including means for attaching a first member to the first channel and attaching a second member to the second channel, wherein the first member and the second member are connected to a fluid current measuring device.

29. The apparatus of claim 28, further including an opening in the first channel and wherein the second channel is configured to permit the fluid current to flow from the first channel to the second channel.

30. The apparatus of claim 29, further including means for directing the fluid current to flow in a first direction through the first channel and in a second direction through the second channel.

31. The apparatus of claim 30, further including means for arranging the first and the second members so that the fluid current impinges upon the first member before the second member.

32. The apparatus of claim 31, wherein the first member and the second member each move in response to the fluid current.

33. The apparatus of claim 28, wherein an outlet of the first channel and an outlet of the second channel are each blocked.

34. The apparatus of claim 18, wherein the at least one member includes a first part having a relatively smaller surface area and a relatively higher elasticity and a second part having a relatively larger surface area and a relatively lower elasticity.
